(19) United States
(12) Patent Application Publication
(10) Pub. No.: US 2016/0237892 A1
(43) Pub. Date: Aug. 18, 2016

(54) STORING ENERGY USING A THERMAL STORAGE UNIT AND AN AIR TURBINE

(71) Applicant: KARL BROTZMANN CONSULTING GMBH, Amberg (DE)

(72) Inventors: Dragan STEVANOVIC, Sulzbach-Rosenberg (DE); Karl BROTZMANN, Amberg (DE)

(21) Appl. No.: 15/029,466

(22) PCT Filed: Oct. 13, 2014
(86) PCT No.: PCT/EP2014/002757

§ 371 Date: Apr. 14, 2016

(30) Foreign Application Priority Data
Oct. 14, 2013 (DE) 10 2013 017 010.9

(51) Int. Cl. F02C 1/04; F02C 7/08; F28D 20/02; F02C 6/16

(52) U.S. Cl. CPC F02C 1/04; F02C 6/16; F02C 7/08; F28D 20/02

(57) ABSTRACT

The invention relates to a method for storing energy by converting the energy into thermal energy and then generating power by means of a gas turbine set with a compressor (1), an expander (6) and a power generator (8), comprising at least one (3) and a second (4) low-temperature storage unit, where the electric energy is stored only in form of high-temperature heat (above the turbine outlet temperature TOT) in a thermal storage unit (5). Depending on the requirements, a compressed gas from the compressor (1) is heated to a temperature approximating the turbine outlet temperature TOT in a low-temperature storage unit (3, 4) and then heated to a temperature level of at least turbine inlet temperature TIT in a high-temperature storage unit (5) using stored heat from electric energy and supplied to a gas turbine (6) in order to generate power.

The invention relates to a method where electric energy is stored in the form of high-temperature heat and compresses a gas as needed, where it heats up stored heat and supplies it to a gas turbine for power generation.

It is well known that energy storage is a means of harmonizing energy consumption and generation. In times where power generation exceeds power requirement, surplus energy is stored. When power requirement is high, the stored energy is lead back. With the increasing proportion of electricity from renewable energy sources, especially from wind and the sun, this topic becomes more and more important, because power generation, and not only power consumption, is very irregular.

### STATE-OF-THE-ART

A well-known method is the energy storage with reversible hydropower plants, also known as pumped-storage plants. Another variation uses two underground caverns on different levels as water reservoir, as described in DE102011117785.

Another technology also suited for large-scale energy storage is the compressed air energy storage in caverns (known as “CAES—compressed air energy storage”. Air is compressed by an electric driven compressor and stored in underground salt caverns. To release the energy, the compressed air is used for natural gas combustion in a gas turbine. The disadvantage here is, however, that high-quality fossil fuels, such as natural gas or kerosene, are needed and that the air pressure is decreased when the compressed air is extracted from the compressed air reservoir. This is disadvantageous for the gas turbine process and reduces the overall efficiency of the process.

There are two possible improvements. One is to position a compressed air reservoir below a liquid column to keep the pressure constant (isobaric storage). The second one is an adiabatic compressed air reservoir that works without additional fuel and has a significantly higher efficiency. A regenerative heat exchanger is used to cool the air after compression and to later, during the discharge, reheat the air with this stored heat before entering the turbine. Investment costs for such reservoirs are, however, very high.

A new alternative for energy storage is the so-called Wind-Gas-Process (originally described in patent specification DE102009018126A1). Surplus electricity from the grid (not only wind power) is used for water electrolysis and the production of hydrogen. Hydrogen is then used together with carbon dioxide for methanization, and the obtained methane is stored in the gas distribution system. At request, this gas is used for power generation, e.g. with a gas turbine or a gas and steam cycle. This process is very complex and contains many process steps with local losses, which makes it inefficient (overall efficiency between 14 and 36%). Investment costs are also very high.

The current patent application relates to a new energy storing facility with relatively low investment costs and a high efficiency degree. Already known and inexpensive components and technologies can be used.

According to the invention, electric current is converted to high-temperature heat and heated in a thermal storage unit. According to demand, a gas is compressed, heated with the stored heat and supplied to a gas turbine for power generation with heat recuperation.

According to the invention, high-temperature heat generated with surplus electricity is stored in a regenerator between entrance and exit temperature of a gas turbine. Thus the overall heat quantity necessary for reaching the entrance temperature is not needed. The remaining heat quantity is only stored for a short time in a system of two or more low-temperature thermal storage units, and heat will only be given off while the gas turbine system is in operation and generates power. Thus the storage capacity for high-temperature heat can be reduced, as well as investment costs for the high-quality storage mass and respective refractory insulation. At the same time, the surplus electricity is only used for the high-temperature heat, which increases the overall efficiency of the storage system.

For the system of two or more low-temperature thermal storage units, inexpensive heat storage mass and insulation can be used. In addition, the storage time in this system is significantly shorter (10 to 60 minutes), so that the storage capacity as well as investment costs can be kept low.

In order to reach a high efficiency of the storage systems, no sophisticated gas turbine with blade cooling is needed, but only a simple and robust turbine, maybe even with radial design, which is used for turbocharger technology. Optimum pressure conditions of course depend on the entrance temperature, but they are significantly lower (between 2 to 7) than for the classic joule cycle without heat recovery.

Depending on turbine construction and process parameter, the overall efficiency degree lies between 35% and 65%. With the models currently on the market an overall efficiency degree of up to 45% can be reached. For even better values, an adapted construction and adapted process parameter are needed, such as multiple intercooling and higher entrance temperatures at low pressure ratios.

If the waste heat from the storage system can also be used, the efficiency degree goes up to 90%.

A further advantage is the fast start ability of such a facility. When electricity is needed in the grid, full capacity is reached within minutes. A facility for the present invention consists of the following components and process steps:
Compressor for the compression of the working fluid (gas)
Gas turbine for the expansion of compressed and preheated working fluid and production of mechanical work
Current generator for power generation from net gained mechanical work (difference between the gained power of the turbine and the used power of the compressor)
At least two low-temperature heat storage units for the recuperation/utilization of the heat content of the turbine exhaust gas
Corresponding control devices for switching between the low-temperature storage units
High-temperature storage unit for storing the heat from surplus electricity
Exhaust gas stack.

In times of electricity surplus in the grid, the high-temperature storage unit is heated up with this electricity from the temperature level at the turbine outlet to the temperature level at the turbine inlet. Depending on the network status and the design capacity, this phase might take several minutes, several hours or several days. When the electricity is needed again in the grid, the gas turbine set (compressor, expander and power generator) is started. First the compressed gas is preheated to turbine outlet temperature in a low-temperature storage unit and then heated to turbine inlet temperature in the high-temperature storage unit. This hot compressed gas expands in the turbine and the power generation. The expanded gas still shows a high efficiency degree and is first further cooled in a second low-temperature storage unit. After a certain period of time, the first low-temperature storage unit is cooled down, and the second one is heated again, so that a changeover takes place. These periods lie within the minute to hour range (usually between 10 to 60 minutes), depending on the design and operational parameter. A power generation phase does not have to follow directly after an electricity surplus phase—they can be several days apart.

### FURTHER EMBODIMENT OF THE INVENTION

In an advantageous embodiment of the invention, the ambient air is to be used as gas working fluid. In special cases a different gas, e.g. nitrogen, can be used.

In a further development of the invention, the air preheated by compression flows through a gas cooler located in front of the first low-temperature storage unit. Waste heat for heating, process heat or other purposes can be generated. At the same time, the exhaust gas temperature and the exhaust gas losses at the chimney can be minimized.

In a further advantageous version, the gas can be conditioned by evaporative cooling with water injection instead of using a recuperative gas cooler. The flow rate through the turbine and its performance is increased, so that the net capacity for power generation is higher. This has a significant influence on the overall efficiency of the storage process.

In a further advantageous version, the inlet and outlet of the high-temperature storage unit are connected by a bypass line with a controllable valve, so that the turbine inlet temperature can be regulated. There are two advantages: first, the turbine output can be regulated and second, heat with a higher temperature than the turbine inlet temperature can be stored in the high-temperature storage unit. The second advantage comes with higher storage capacity at the same dimensions and mass of the storage unit and therefore lower specific investment costs.

In a further advantageous development of the invention, there is a downstream fuel supply at the outlet of the high-temperature storage unit, so that a relatively small amount of natural gas or another gaseous or liquid fuel can be added in order to increase the gas temperature in front of the turbine inlet. That way power can be generated longer than planned if required by the grid conditions, despite the sharp drop in temperature at the outlet of the high-temperature storage unit.

It is advantageous to use three or more low-temperature storage units, in order to enable a smooth changeover between two operating phases without pressure surges. The number of storage units depends on the operating pressure and capacity of the facility. Using several storage units can compensate for the pressure loss in both operating phases, so that more than one unit is switched on during the phase with low operating pressure, with the respective flow rate reduction through every unit and an extension of the phase time. Such changeover processes are already known from DE 100 39 246 C2 or DE 10 2009 038 322 A1.

When a facility has a very high energy storage capacity, it is advantageous to install several high-temperature storage units, in order to reduce the dimension of each unit and to minimize investment costs. In that case, additional changeover devices are needed between the high-temperature storage units. It is advantageous to place these changeover devices in front of (and not behind) the separate high-temperature storage units, where the temperatures are significantly lower. That saves investment costs and at the same time prolongs the service life of these devices.

Low-temperature storage units are also suited for the release of the stored thermal energy, e.g. in the form of warm air. Because of the low investment costs and the very good heat transfer, bulk regenerators are especially suited as low-temperature storage units. In particular, bulk regenerators known from EP 0620 909 B1 or DE 42 36 619 C2 can be applied. Bulk materials are natural materials such as gravel, Eifel lava or lime grit used as heat storage mass for the low-temperature storage units.

High-temperature storage units are also suited for the release of the stored thermal energy, e.g. in the form of hot air. Bulk regenerators are particularly suited as high-temperature storage units. Bulk regenerators known from EP 0620 909 B1 or DE 42 36 619 C2 can also be applied. However, because of the higher temperatures, also at the cold sides of the regenerator, a simpler design, e.g. in the form of axial-flow vertical cylinders, is better suited.

For the high-temperature storage units, a bulk material as heat storage mass is preferred that is sufficiently resistant against high temperatures, such as alumina (Al₂O₃), fireclay, lime, SiC or zirconium.

Preferably, the heating elements for the conversion of electric energy to heat, which takes place in the high-temperature storage unit, are directly inserted into the bulk material, e.g. in the form of spirals located one above the other. The horizontal distance between the wire in a spiral has to be about the same as the vertical distance between two spirals, in order to enable an even heat transfer.

In order to get the desired electrical power and nominal heat dissipation from the wire surface, an optimum ratio between the specific wire resistor, wire diameter and overall length has to be achieved. It will be advantageous, to connect several or all spirals in a high-temperature storage unit in order to increase the line length.

A wire of stainless steel or heat-resistant steel can serve as heating wire, depending on the temperature and the applied gas/working fluid.

Advantages of the invention are shown as execution examples in the drawings and described below.

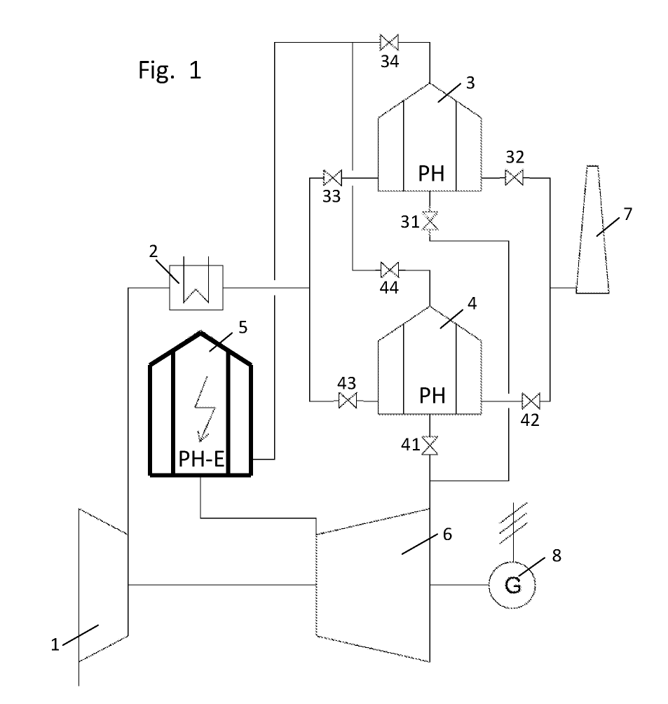

FIG. 1 a schematic block diagram with all main components of the facility and its connections;

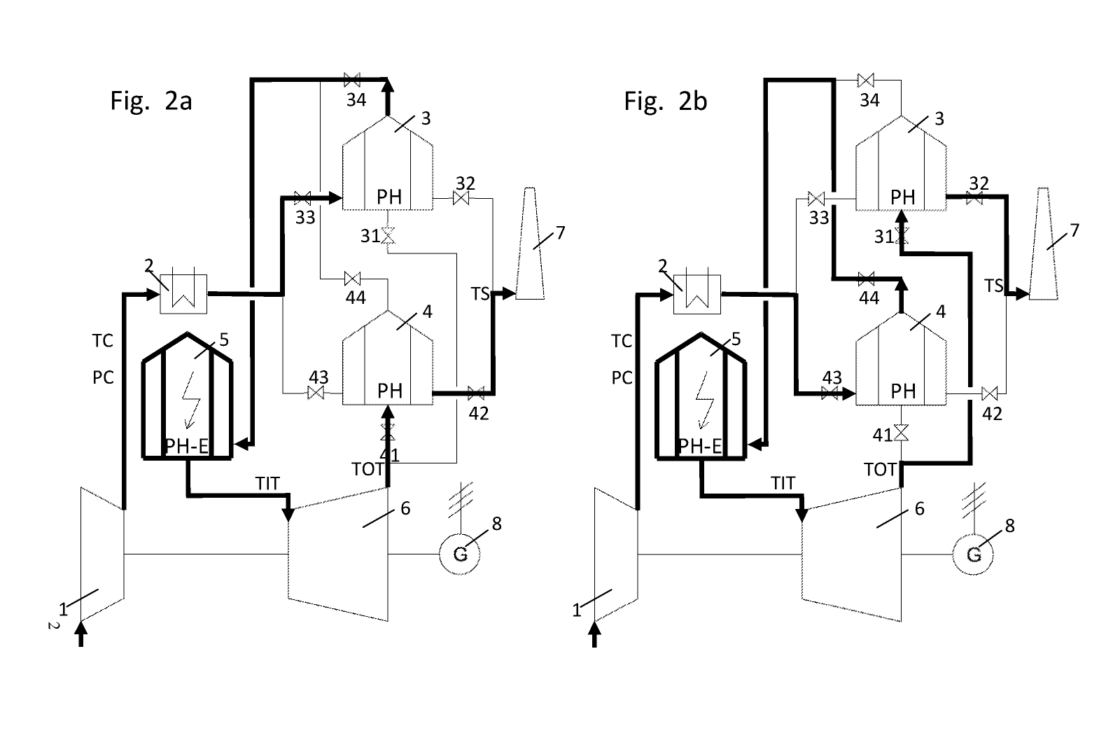

FIG. 2a and FIG. 2b the same block diagram as in FIG. 1, but with a display of the flow paths of the gases during the power generation phases;

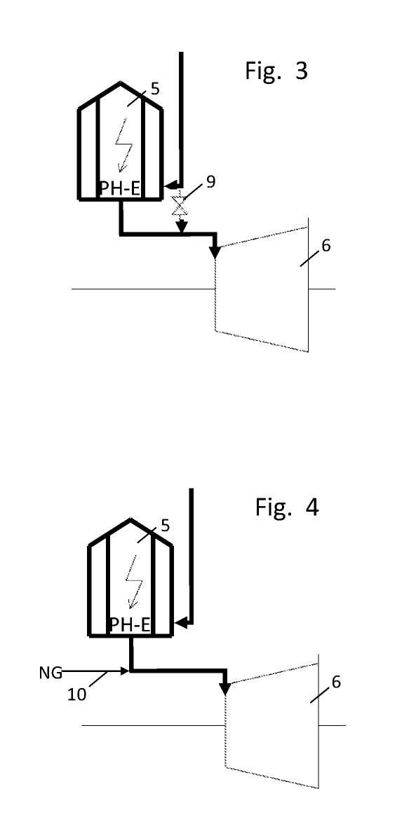

FIG. 3 bypass line with bypass valve 9;

FIG. 4 supply of natural gas NG or other gaseous or liquid fuels 10; and

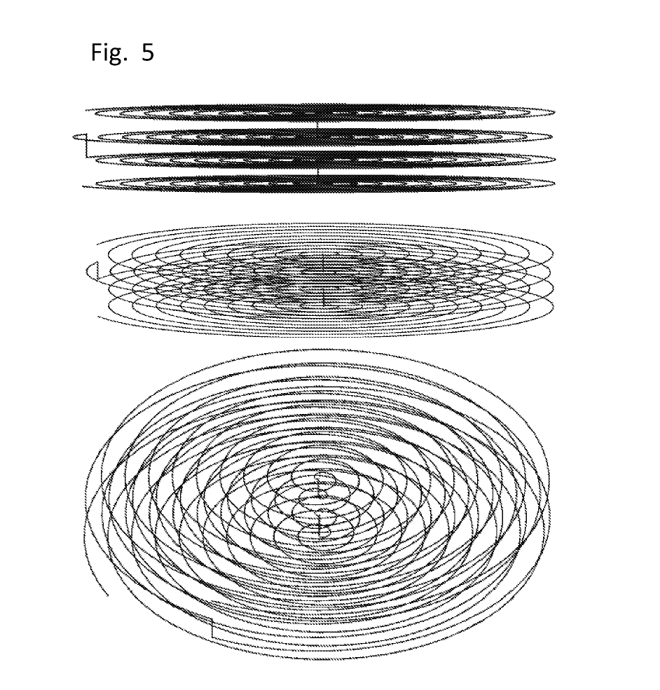

FIG. 5 the heating elements in the high-temperature storage unit 5 in the form of connected spirals located one above the other.

FIG. 1 shows a schematic flow diagram of the system for the thermal storage of surplus electricity and its reproduction at lack of electricity in the grid. This system includes a set of gas turbines with compressor 1, turbine 6 and power generator 8, a high-temperature storage unit 5, two smaller low-temperature storage units 3, 4 with respective changeover devices 31-34 and 41-44, as well as a gas cooler 2 and discharge chimney 7.

During a power storage phase, high-temperature storage unit 5 is heated with electricity from turbine outlet temperature TOT to at least turbine inlet temperature TIT. The conversion from electric to thermal energy can occur through electric resistance or induction. This phase can take several minutes, hours or days, depending on the power requirements and the design of the components.

FIG. 2a shows the flow paths of the gas during a power generation phase. The ambient air is compressed to a pressure PC in compressor 1 and heated to a temperature TC, which is significantly higher than the ambient temperature. In order to utilize this heat and at the same time minimize the chimney losses, the compressed air is cooled in gas cooler 2, and the gained heat is used for heating or other purposes. When changeover devices 33 and 34 are open, the cooled air flows through a first low-temperature storage unit 3, where it is heated to a temperature close to turbine outlet temperature TOT, but significantly higher than TC, by stored heat. The preheated air flows through high-temperature storage unit 5, where its temperature rises to at least turbine inlet temperature TIT through the stored high-temperature heat of electric origin. Compressed air at temperature TIT enters turbine 6, where the expansion to ambient pressure takes place, so that the temperature drops to TOT. Since changeover devices 41 and 42 are also open, the expanded air flows through a second low-temperature storage unit 4, gives off its heat at the storage mass, cools to temperature TS and leaves the system through a chimney 7.

After a certain time, usually between 10 and 60 minutes, changeover devices 33, 34, 41 and 42 close and changeover devices 31, 32, 43 and 44 open, so that low-temperature storage units 3 and 4 switch roles, as shown in FIG. 2b.

Instead of cooling the compressed air in a convective heat exchanger 2, water can be injected and cool through water evaporation. The possibility to utilize the accrued waste heat is lost that way, but at the same time the mass flow through turbine 6 and thus the performance and especially the overall efficiency degree of the process increases.

FIG. 3 shows a bypass line with bypass valve 9 in order to bypass high-temperature storage unit 5 with a partial flow, in order to get a turbine inlet temperature TIT, which is lower than the outlet temperature from high-temperature storage unit 5. That way even higher temperatures can be stored in high-temperature storage unit 5 and increase its heat capacity. In addition, bypass valve 9 can regulate the performance of turbine 6.

FIG. 4 shows the possibility to add natural gas NG or another gaseous or liquid fuel through line 10 to the line between high-temperature storage unit 5 and turbine 6 in order to reach a higher turbine inlet temperature TIT. This can be of interest when the discharge time takes longer than planned due to the conditions in the grid and the air temperature from the high-temperature storage unit drops below the nominal turbine inlet temperature TIT.

A possible advantageous design of the electric heating elements in the form of connected spirals located one above the other is shown in FIG. 5. This design is especially advantageous for the bulk material as heat storage mass, because it can be distributed freely and evenly around the spirals. In order to increase the overall length of the heating cables, the spirals are connected in the middle or at the end respectively. Here, for example, four spirals are shown from three different perspectives, in order to better outline the mentioned connections.

All characteristics disclosed in the application documents are claimed as essential to the invention provided they are novel over the prior art separately or in combination.

### LIST OF REFERENCE SIGNS

1 Compressor

2 Heat exchanger, gas cooler

3 First low-temperature storage unit

4 Second low-temperature storage unit

5 High-temperature storage unit, heated electrically

6 Turbine, Gas expander

7 Chimney

8 Power generator

9 Bypass line with bypass valve

10 Supply of natural gas or another gaseous or liquid fuel

31, 32, 33, 34 Changeover units at the first low-temperature storage unit

41, 42, 43, 44 Changeover units at the second low-temperature storage unit

PH-E Electrically heated high-temperature storage unit

PH Low-temperature storage unit

PC Pressure after the compressor

TC Temperature after the compressor

TIT Turbine inlet temperature

TOT Turbine outlet temperature

TS Temperature at the chimney

NG Natural gas or another gaseous or liquid fuel

1-15. (canceled)

16. Method for storing energy by converting the energy into thermal energy and then generating power by means of a gas turbine set with a compressor (1), an expander (6) and a power generator (8), comprising at least a first (3) and a second (4) low-temperature storage unit, characterized in that the electric energy is stored only in a form of high-temperature heat (above the turbine outlet temperature TOT) in a thermal storage unit (5), and that during the power generation phase, a compressed gas from the compressor (1) is heated to a temperature approximating the turbine outlet temperature (TOT) in a low-temperature storage unit (3, 4) and then heated to a temperature level of at least turbine inlet temperature (TIT) in a high-temperature storage unit (5).

17. Method according to claim 16, characterized in that the cooling in the high-temperature storing unit (5) during a power generation phase only takes place down to the turbine outlet temperature TOT.

18. Method according to claim 16, characterized in that the compressed gas is supplied to at least one heat exchanger (2) in order to decouple the gained waste heat as usable heat.

19. Method according to claim 16, characterized in that the compressed gas is cooled by water injection after the compressor (1).

20. Method according to claim 16, characterized in that the high-temperature storage unit (5) is heated to a temperature above the turbine inlet temperature TIT using electric energy.

21. Method according to claim 16, characterized in that the turbine inlet temperature and the turbine output can be regulated through a bypass line and a bypass valve (9).

22. Method according to claim 16, characterized in that the gas serving as working fluid is air or another oxygenic gas during the power generation phase.

23. Method according to claim 16, characterized in that a small amount of natural gas or another gaseous or liquid fuel is supplied through a line (10) in front of the turbine inlet (6).

24. Method according to claim 16, characterized in that the conversion of electric energy to high-temperature heat for the storage unit (5) occurs through electric resistance or induction.

25. Device for storing energy by converting the energy into thermal energy and then generating power by means of a gas turbine set with a compressor (1), an expander (6) and a power generator (8), comprising at least one (3) and a second (4) low-temperature storage unit, characterized in that at least one downstream high-temperature storage unit (5) is installed for heating the working fluid after the low-temperature storage unit (3, 4) up to turbine inlet temperature (TIT).

26. Device according to claim 25, characterized in that a downstream heat exchanger (2) is installed behind the compressor (1), which cools the working fluid and decouples the gained waste heat as usable heat.

27. Device according to claim 25, characterized in that a water injection is planned downstream of the compressor (1).

28. Device according to claim 25, characterized in that a bypass line with a bypass valve (9) is installed downstream between inlet and outlet of the high-temperature storage unit (5).

29. Device according to claim 25, characterized in that a line (10) for fuel supply is planned in front of the turbine inlet (6).

30. Device according to claims 25, characterized in that a changeover device for alternately switching on at least one first low-temperature storage unit (3) and at least one second low-temperature storage unit (4) in the lines behind the turbine (6) or behind the compressor (1) is planned.

31. Method according to claim 22, characterized in that a small amount of natural gas or another gaseous or liquid fuel is supplied through a line (10) in front of the turbine inlet (6).
